(19) United States
(12) Patent Application Publication
(10) Pub. No.: US 2024/0070902 A1
(43) Pub. Date: Feb. 29, 2024

(54) Presenting Content Based on a Point of Interest

(71) Applicant: Apple Inc., Cupertino, CA (US)

(72) Inventors: Richard P Lozada, Cupertino, CA (US); Peter Burgner, Venice, CA (US); Thomas J Moore, Northglenn, CO (US)

(21) Appl. No.: 18/342,477

(22) Filed: Jun. 27, 2023

Related U.S. Application Data
(60) Provisional application No. 63/400,302, filed on Aug. 23, 2022.

(51) Int. Cl. G06T 7/73; G06F 3/01; G06T 7/90

(52) U.S. Cl. CPC G06T 7/73; G06F 3/011; G06T 7/90; G06T 2207/30204

(57) ABSTRACT

An electronic device may use one or more sensors to detect a user intent for content associated with a point of interest in the physical environment of the user. In response to the user intent for content, the electronic device may transmit information associated with the point of interest to an external server. The transmitted information may include depth information, color information, feature point information, location information, etc. The external server may compare the received information to a database of points of interest and identify a matching point of interest in the database. The external server then transmits additional contextual information and/or application information associated with the matching point of interest to the electronic device. The electronic device may run an application and/or present content based on the received information associated with the matching point of interest.

This application claims priority to U.S. provisional patent application No. 63/400,302, filed Aug. 23, 2022, which is hereby incorporated by reference herein in its entirety.

### BACKGROUND

This relates generally to electronic devices, and, more particularly, to electronic devices with one or more sensors.

Some electronic devices include sensors for obtaining sensor data for a physical environment around the electronic device. If care is not taken, the sensors may consume more power than is desired.

### SUMMARY

An electronic device may include one or more sensors, one or more processors, and memory storing instructions configured to be executed by the one or more processors, the instructions for: obtaining, via a first subset of the one or more sensors, first sensor data and, in accordance with a determination, based on the first sensor data, of a user intent for content: obtaining, via a second subset of the one or more sensors, depth information for a physical environment, wherein the second subset of the one or more sensors comprises at least one sensor not included within the first subset of the one or more sensors, transmitting first information to at least one external server, wherein the first information comprises the depth information, after transmitting the first information to the at least one external server, receiving second information from the at least one external server, wherein the second information comprises contextual information for the physical environment, and presenting content based at least on the second information.

### BRIEF DESCRIPTION OF THE DRAWINGS

FIG. 1 is a schematic diagram of an illustrative electronic device in accordance with some embodiments.

FIG. 2 is a schematic diagram of an illustrative external server in accordance with some embodiments.

FIGS. 3 and 4 are top views of a three-dimensional environment with an illustrative electronic device and a point of interest in accordance with some embodiments.

FIG. 5 is a state diagram showing illustrative operating modes for a sensor in an electronic device in accordance with some embodiments.

FIG. 6 is a view of a point of interest through an illustrative display of an electronic device in accordance with some embodiments.

FIG. 7 is a flowchart showing an illustrative method for operating an electronic device in accordance with some embodiments.

### DETAILED DESCRIPTION

Head-mounted devices may display different types of extended reality content for a user. The head-mounted device may display a virtual object that is perceived at an apparent depth within the physical environment of the user. Virtual objects may sometimes be displayed at fixed locations relative to the physical environment of the user. For example, consider an example where a user's physical environment includes a table. A virtual object may be displayed for the user such that the virtual object appears to be resting on the table. As the user moves their head and otherwise interacts with the XR environment, the virtual object remains at the same, fixed position on the table (e.g., as if the virtual object were another physical object in the XR environment). This type of content may be referred to as world-locked content (because the position of the virtual object is fixed relative to the physical environment of the user).

Other virtual objects may be displayed at locations that are defined relative to the head-mounted device or a user of the head-mounted device. First, consider the example of virtual objects that are displayed at locations that are defined relative to the head-mounted device. As the head-mounted device moves (e.g., with the rotation of the user's head), the virtual object remains in a fixed position relative to the head-mounted device. For example, the virtual object may be displayed in the front and center of the head-mounted device (e.g., in the center of the device's or user's field-of-view) at a particular distance. As the user moves their head left and right, their view of their physical environment changes accordingly. However, the virtual object may remain fixed in the center of the device's or user's field of view at the particular distance as the user moves their head (assuming gaze direction remains constant). This type of content may be referred to as head-locked content. The head-locked content is fixed in a given position relative to the head-mounted device (and therefore the user's head which is supporting the head-mounted device). The head-locked content may not be adjusted based on a user's gaze direction. In other words, if the user's head position remains constant and their gaze is directed away from the head-locked content, the head-locked content will remain in the same apparent position.

Second, consider the example of virtual objects that are displayed at locations that are defined relative to a portion of the user of the head-mounted device (e.g., relative to the user's torso). This type of content may be referred to as body-locked content. For example, a virtual object may be displayed in front and to the left of a user's body (e.g., at a location defined by a distance and an angular offset from a forward-facing direction of the user's torso), regardless of which direction the user's head is facing. If the user's body is facing a first direction, the virtual object will be displayed in front and to the left of the user's body. While facing the first direction, the virtual object may remain at the same, fixed position relative to the user's body in the XR environment despite the user rotating their head left and right (to look towards and away from the virtual object). However, the virtual object may move within the device's or user's field of view in response to the user rotating their head. If the user turns around and their body faces a second direction that is the opposite of the first direction, the virtual object will be repositioned within the XR environment such that it is still displayed in front and to the left of the user's body. While facing the second direction, the virtual object may remain at the same, fixed position relative to the user's body in the XR environment despite the user rotating their head left and right (to look towards and away from the virtual object).

In the aforementioned example, body-locked content is displayed at a fixed position/orientation relative to the user's body even as the user's body rotates. For example, the virtual object may be displayed at a fixed distance in front of the user's body. If the user is facing north, the virtual object is in front of the user's body (to the north) by the fixed distance. If the user rotates and is facing south, the virtual object is in front of the user's body (to the south) by the fixed distance.

Alternatively, the distance offset between the body-locked content and the user may be fixed relative to the user whereas the orientation of the body-locked content may remain fixed relative to the physical environment. For example, the virtual object may be displayed in front of the user's body at a fixed distance from the user as the user faces north. If the user rotates and is facing south, the virtual object remains to the north of the user's body at the fixed distance from the user's body.

Body-locked content may also be configured to always remain gravity or horizon aligned, such that head and/or body changes in the roll orientation would not cause the body-locked content to move within the XR environment. Translational movement may cause the body-locked content to be repositioned within the XR environment to maintain the fixed distance from the user. Subsequent descriptions of body-locked content may include both of the aforementioned types of body-locked content.

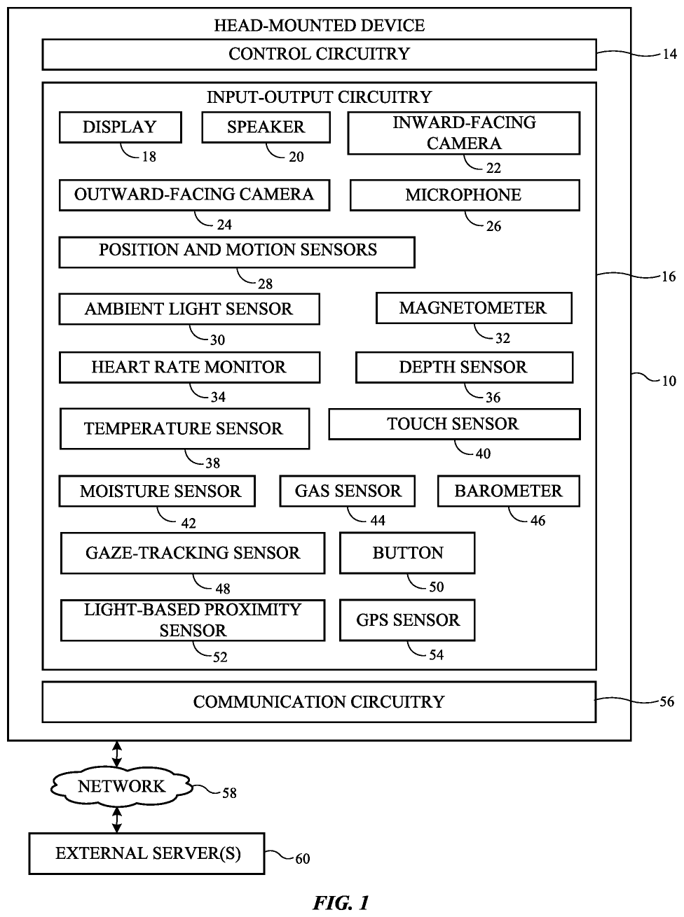

A schematic diagram of an illustrative electronic device is shown in FIG. 1. As shown in FIG. 1, electronic device 10 (sometimes referred to as head-mounted device 10, system 10, head-mounted display 10, etc.) may have control circuitry 14. In addition to being a head-mounted device, electronic device 10 may be other types of electronic devices such as a cellular telephone, laptop computer, speaker, computer monitor, electronic watch, tablet computer, etc. Control circuitry 14 may be configured to perform operations in head-mounted device 10 using hardware (e.g., dedicated hardware or circuitry), firmware and/or software. Software code for performing operations in head-mounted device 10 and other data is stored on non-transitory computer readable storage media (e.g., tangible computer readable storage media) in control circuitry 14. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 14. The processing circuitry may include application-specific integrated circuits with processing circuitry, one or more microprocessors, digital signal processors, graphics processing units, a central processing unit (CPU) or other processing circuitry.

Head-mounted device 10 may include input-output circuitry 16. Input-output circuitry 16 may be used to allow a user to provide head-mounted device 10 with user input. Input-output circuitry 16 may also be used to gather information on the environment in which head-mounted device 10 is operating. Output components in circuitry 16 may allow head-mounted device 10 to provide a user with output.

As shown in FIG. 1, input-output circuitry 16 may include a display such as display 18. Display 18 may be used to display images for a user of head-mounted device 10. Display 18 may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 18 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 18 is opaque, the display may also optionally display entirely computer-generated content (e.g., without displaying images of the physical environment).

Display 18 may include one or more optical systems (e.g., lenses) (sometimes referred to as optical assemblies) that allow a viewer to view images on display(s) 18. A single display 18 may produce images for both eyes or a pair of displays 18 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

Input-output circuitry 16 may include various other input-output devices. For example, input-output circuitry 16 may include one or more speakers 20 that are configured to play audio and one or more microphones 26 that are configured to capture audio data from the user and/or from the physical environment around the user.

Input-output circuitry 16 may also include one or more cameras such as an inward-facing camera 22 (e.g., that face the user's face when the head-mounted device is mounted on the user's head) and an outward-facing camera 24 (that face the physical environment around the user when the head-mounted device is mounted on the user's head). Cameras 22 and 24 may capture visible light images, infrared images, or images of any other desired type. The cameras may be stereo cameras if desired. Inward-facing camera 22 may capture images that are used for gaze-detection operations, in one possible arrangement. Outward-facing camera 24 may capture pass-through video for head-mounted device 10.

As shown in FIG. 1, input-output circuitry 16 may include position and motion sensors 28 (e.g., compasses, gyroscopes, accelerometers, and/or other devices for monitoring the location, orientation, and movement of head-mounted device 10, satellite navigation system circuitry such as Global Positioning System circuitry for monitoring user location, etc.). Using sensors 28, for example, control circuitry 14 can monitor the current direction in which a user's head is oriented relative to the surrounding environment (e.g., a user's head pose). One or more of cameras 22 and 24 may also be considered part of position and motion sensors 28. The cameras may be used for face tracking (e.g., by capturing images of the user's jaw, mouth, etc. while the device is worn on the head of the user), body tracking (e.g., by capturing images of the user's torso, arms, hands, legs, etc. while the device is worn on the head of user), and/or for localization (e.g., using visual odometry, visual inertial odometry, or other simultaneous localization and mapping (SLAM) technique).

Input-output circuitry 16 may also include other sensors and input-output components if desired. As shown in FIG. 1, input-output circuitry 16 may include an ambient light sensor 30. The ambient light sensor may be used to measure ambient light levels around head-mounted device 10. The ambient light sensor may measure light at one or more wavelengths (e.g., different colors of visible light and/or infrared light).

Input-output circuitry 16 may include a magnetometer 32. The magnetometer may be used to measure the strength and/or direction of magnetic fields around head-mounted device 10.

Input-output circuitry 16 may include a heart rate monitor 34. The heart rate monitor may be used to measure the heart rate of a user wearing head-mounted device 10 using any desired techniques.

Input-output circuitry 16 may include a depth sensor 36. The depth sensor may be a pixelated depth sensor (e.g., that is configured to measure multiple depths across the physical environment) or a point sensor (that is configured to measure a single depth in the physical environment). The depth sensor (whether a pixelated depth sensor or a point sensor) may use phase detection (e.g., phase detection autofocus pixel(s)) or light detection and ranging (LIDAR) to measure depth. Any combination of depth sensors may be used to determine the depth of physical objects in the physical environment.

Input-output circuitry 16 may include a temperature sensor 38. The temperature sensor may be used to measure the temperature of a user of head-mounted device 10, the temperature of head-mounted device 10 itself, or an ambient temperature of the physical environment around head-mounted device 10.

Input-output circuitry 16 may include a touch sensor 40. The touch sensor may be, for example, a capacitive touch sensor that is configured to detect touch from a user of the head-mounted device.

Input-output circuitry 16 may include a moisture sensor 42. The moisture sensor may be used to detect the presence of moisture (e.g., water) on, in, or around the head-mounted device.

Input-output circuitry 16 may include a gas sensor 44. The gas sensor may be used to detect the presence of one or more gasses (e.g., smoke, carbon monoxide, etc.) in or around the head-mounted device.

Input-output circuitry 16 may include a barometer 46. The barometer may be used to measure atmospheric pressure, which may be used to determine the elevation above sea level of the head-mounted device.

Input-output circuitry 16 may include a gaze-tracking sensor 48 (sometimes referred to as gaze-tracker 48 and gaze-tracking system 48). The gaze-tracking sensor 48 may include a camera and/or other gaze-tracking sensor components (e.g., light sources that emit beams of light so that reflections of the beams from a user's eyes may be detected) to monitor the user's eyes. Gaze-tracker 48 may face a user's eyes and may track a user's gaze. A camera in the gaze-tracking system may determine the location of a user's eyes (e.g., the centers of the user's pupils), may determine the direction in which the user's eyes are oriented (the direction of the user's gaze), may determine the user's pupil size (e.g., so that light modulation and/or other optical parameters and/or the amount of gradualness with which one or more of these parameters is spatially adjusted and/or the area in which one or more of these optical parameters is adjusted is adjusted based on the pupil size), may be used in monitoring the current focus of the lenses in the user's eyes (e.g., whether the user is focusing in the near field or far field, which may be used to assess whether a user is day dreaming or is thinking strategically or tactically), and/or other gaze information. Cameras in the gaze-tracking system may sometimes be referred to as inward-facing cameras, gaze-detection cameras, eye-tracking cameras, gaze-tracking cameras, or eye-monitoring cameras. If desired, other types of image sensors (e.g., infrared and/or visible light-emitting diodes and light detectors, etc.) may also be used in monitoring a user's gaze. The use of a gaze-detection camera in gaze-tracker 48 is merely illustrative.

Input-output circuitry 16 may include a button 50. The button may include a mechanical switch that detects a user press during operation of the head-mounted device.

Input-output circuitry 16 may include a light-based proximity sensor 52. The light-based proximity sensor may include a light source (e.g., an infrared light source) and an image sensor (e.g., an infrared image sensor) configured to detect reflections of the emitted light to determine proximity to nearby objects.

Input-output circuitry 16 may include a global positioning system (GPS) sensor 54. The GPS sensor may determine location information for the head-mounted device. The GPS sensor may include one or more antennas used to receive GPS signals. The GPS sensor may be considered a part of position and motion sensors 28.

Input-output circuitry 16 may include any other desired components (e.g., capacitive proximity sensors, other proximity sensors, strain gauges, pressure sensors, audio components, haptic output devices such as vibration motors, light-emitting diodes, other light sources, etc.).

Head-mounted device 10 may also include communication circuitry 56 to allow the head-mounted device to communicate with external equipment (e.g., a tethered computer, a portable device such as a handheld device or laptop computer, one or more external servers, or other electrical equipment). Communication circuitry 56 may be used for both wired and wireless communication with external equipment.

Communication circuitry 56 may include radio-frequency (RF) transceiver circuitry formed from one or more integrated circuits, power amplifier circuitry, low-noise input amplifiers, passive RF components, one or more antennas, transmission lines, and other circuitry for handling RF wireless signals. Wireless signals can also be sent using light (e.g., using infrared communications).

The radio-frequency transceiver circuitry in wireless communications circuitry 56 may handle wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHz), a cellular ultra-high band (UHB) (e.g., from 3300 to 5000 MHz, or other cellular communications bands between about 600 MHz and about 5000 MHz (e.g., 3G bands, 4G LTE bands, 5G New Radio Frequency Range 1 (FR1) bands below 10 GHz, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands.

The radio-frequency transceiver circuitry may include millimeter/centimeter wave transceiver circuitry that supports communications at frequencies between about 10 GHz and 300 GHz. For example, the millimeter/centimeter wave transceiver circuitry may support communications in Extremely High Frequency (EHF) or millimeter wave communications bands between about 30 GHz and 300 GHz and/or in centimeter wave communications bands between about 10 GHz and 30 GHz (sometimes referred to as Super High Frequency (SHF) bands). As examples, the millimeter/centimeter wave transceiver circuitry may support communications in an IEEE K communications band between about 18 GHz and 27 GHz, a Kₐ communications band between about 26.5 GHz and 40 GHz, a Kᵤ communications band between about 12 GHz and 18 GHz, a V communications band between about 40 GHz and 75 GHz, a W communications band between about 75 GHz and 110 GHz, or any other desired frequency band between approximately 10 GHz and 300 GHz. If desired, the millimeter/centimeter wave transceiver circuitry may support IEEE 802.11ad communications at 60 GHz (e.g., WiGig or 60 GHz Wi-Fi bands around 57-61 GHz), and/or 5^{th} generation mobile networks or 5^{th} generation wireless systems (5G) New Radio (NR) Frequency Range 2 (FR2) communications bands between about 24 GHz and 90 GHz.

Antennas in wireless communications circuitry 56 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of these designs, etc. Different types of antennas may be used for different bands and combinations of bands. For example, one type of antenna may be used in forming a local wireless link and another type of antenna may be used in forming a remote wireless link antenna.

During operation, head-mounted device 10 may use communication circuitry 56 to communicate with one or more external servers 60 through network(s) 58. Examples of communication network(s) 58 include local area networks (LAN) and wide area networks (WAN) (e.g., the Internet). Communication network(s) 58 may be implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

External server(s) 60 may be implemented on one or more standalone data processing apparatus or a distributed network of computers. External server 60 may provide information such as point of interest information to head-mounted device 10 (via network 58) in response to information from head-mounted device 10.

Head-mounted device 10 may communicate with external server(s) 60 to obtain information on a point of interest. For example, the head-mounted device may, in response to user input, send a request for point of interest information to external server(s) 60. The request for point of interest information may include various information for identifying a point of interest near the head-mounted device (e.g., within the field-of-view of the user). The information transmitted by the head-mounted device for identifying a point of interest may include location information, pose information, graphical marker information, color information, feature point information, and/or depth information. The external server(s) may compare the received information to a point of interest database and identify if there is a match to a point of interest in the point of interest database. When there is a match, the external server(s) may send information regarding the point of interest such as application information and contextual information to the head-mounted device. The head-mounted device may then present content to the user based on the information regarding the point of interest received from the external server(s).

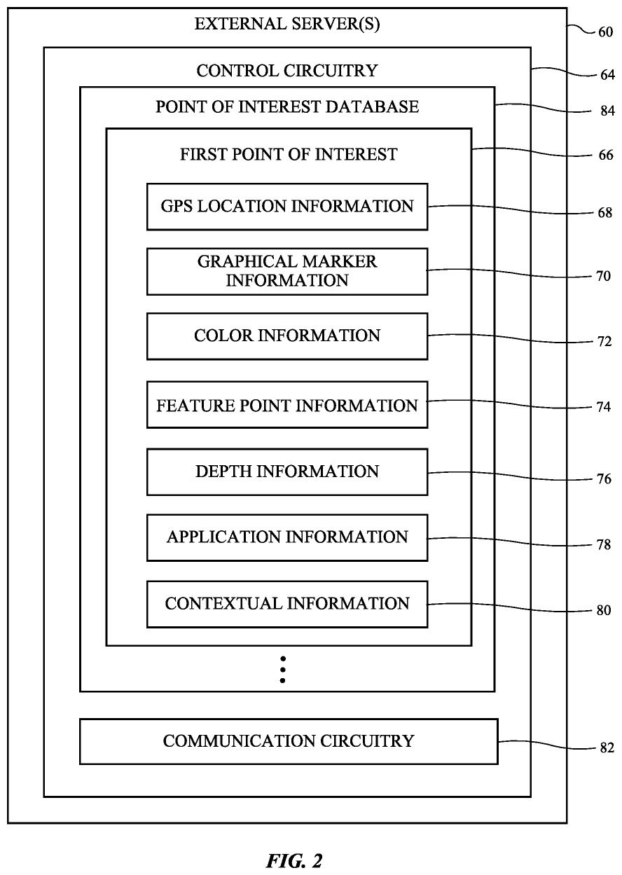

A schematic diagram of an illustrative external server 60 is shown in FIG. 2. As shown in FIG. 2, external server(s) 60 may have control circuitry 64. Control circuitry 64 may be configured to perform operations using hardware (e.g., dedicated hardware or circuitry), firmware and/or software. Software code for performing operations in external server(s) 60 and other data is stored on non-transitory computer readable storage media (e.g., tangible computer readable storage media) in control circuitry 64. The software code may sometimes be referred to as software, data, program instructions, instructions, or code. The non-transitory computer readable storage media (sometimes referred to generally as memory) may include non-volatile memory such as non-volatile random-access memory (NVRAM), one or more hard drives (e.g., magnetic drives or solid-state drives), one or more removable flash drives or other removable media, or the like. Software stored on the non-transitory computer readable storage media may be executed on the processing circuitry of control circuitry 64. The processing circuitry may include application-specific integrated circuits with processing circuitry, one or more microprocessors, digital signal processors, graphics processing units, a central processing unit (CPU) or other processing circuitry.

External server(s) 60 also include communication circuitry 82. Communication circuitry 82 in FIG. 2 may have the same functionality as communication circuitry 56 in FIG. 1 and the descriptions of communication circuitry 56 therefore fully apply to communication circuitry 82. For simplicity the description of circuitry 82 will not be duplicated herein in connection with FIG. 2. External server(s) 60 may use communication circuitry 82 to communicate with head-mounted device 10 through network 58.

As shown in FIG. 2, control circuitry 64 may include a point of interest database 84. The point of interest database may include information for a plurality of points of interest. FIG. 2 shows a first point of interest 66. In general, the point of interest database 84 may include information for any desired number (n) of points of interest.

Control circuitry 64 may store various types of information for each given point of interest. In the example of FIG. 2, the information stored for each point of interest includes GPS location information 68, graphical marker information 70, color information 72, feature point information 74, depth information 76, application information 78, and contextual information 80. Additional types of information may also be included for each point of interest if desired.

GPS location information 68 may include the GPS coordinates (e.g., a latitude and longitude) for the point of interest. The GPS coordinates may be used to identify if a user is nearby a particular point of interest when requesting point of interest (POI) information. For example, only points of interest with GPS locations within a threshold distance of the user's GPS location may be considered as possible matches when the user is seeking POI information.

Points of interest in a physical environment may include graphical markers. During operation, the user may capture an image of the graphical marker and transmit the image (or information derived from the image) to external server(s) 60. Each point of interest in point of interest database 84 may have a unique graphical marker. Therefore, the identity of the graphical marker from the user may be used to identify a point of interest associated with the graphical marker.

The stored graphical marker information 70 for each point of interest may include the appearance of the graphical marker (or information represented by the graphical marker) as well as a precise location and orientation of the graphical marker. For example, the graphical marker information may include precise coordinates for the graphical marker as well as an orientation within three-dimensional space for the graphical marker. This information may, for example, be loaded to the point of interest database, when the graphical marker is initially disposed on the point of interest. Upon receiving an image of a graphical marker (or other identification for the graphical marker) from a head-mounted device, external server(s) 60 may identify the corresponding point of interest and the graphical marker information associated with that graphical marker. The external server(s) may transmit the precise location and orientation of the graphical marker to the head-mounted device. This information may be useful in helping the head-mounted device determine its precise location.

For example, consider a scenario where a user of a head-mounted device views a point of interest with a graphical marker. Using GPS sensor 54 alone, head-mounted device 10 may know its location within a first range of uncertainty (e.g., within 3 feet). The head-mounted device may also capture an image of the graphical marker and transmit the image (or graphical marker information from the image) to external server(s) 60. The external server(s) may identify the graphical marker and transmit the precise location and orientation of the graphical marker to the head-mounted device. The head-mounted device may then determine its position relative to the graphical marker within a second range of uncertainty (e.g., within 3 inches) that is smaller than the first range of uncertainty. Since the location of the graphical marker is known (from the information received from the external server(s)), the position of the head-mounted device relative to the graphical marker may be used to precisely determine the location of the head-mounted device within the second, smaller range of uncertainty (e.g., within 3 inches).

Color information 72 may include the color of various physical objects associated with the point of interest. For example, color information may include a color associated with a building, a door, and/or a sign for the point of interest.

Feature point information 74 may include various feature points associated with the point of interest. The feature points may include edge locations, corner locations, point locations, or other feature point information associated with the physical environment.

Depth information 76 may include a three-dimensional representation of the point of interest (sometimes referred to as a depth map).

Application information 78 may include information for an application that is associated with a point of interest. For example, consider the example where the first point of interest 66 is a given store. The given store may have an associated application. In response to identifying that the user is requesting information regarding the first point of interest, external server(s) 60 may transmit application information 78 to the head-mounted device 10. Head-mounted device 10 may then use application information 78 to run an application associated with the given store.

Contextual information 80 may include contextual information associated with the point of interest. The contextual information may include, for example, hours of operation for the point of interest, a menu for the point of interest (e.g., if the point of interest is a restaurant), a description of the point of interest (e.g., if the point of interest is a business the description may describe the mission statement for the business), etc. In general, any desired contextual information associated with the point of interest may be stored in contextual information 80. In response to identifying that the user is requesting information regarding the first point of interest, external server(s) 60 may transmit contextual information 80 to the head-mounted device 10. Head-mounted device 10 may then use contextual information 80 to present content regarding the point of interest to the user. For example, using the aforementioned examples, the head-mounted device may display the hours of operation, the description, and/or the menu associated with the point of interest.

During operation, head-mounted device 10 may transmit a request for POI information to external server(s) 60 with one or more of location information for the head-mounted device (e.g., gathered using GPS sensor 54 and/or using cell tower triangulation), pose information (e.g., gathered using position and motion sensors 28), graphical marker information (e.g., based on one or more images captured with outward-facing camera 24), point of gaze information (e.g., gathered using gaze-tracking sensor 48), color information (e.g., based on one or more images captured with outward-facing camera 24), feature point information (e.g., based on one or more images captured with outward-facing camera 24 and/or data from depth sensor 36), depth information (e.g., gathered using depth sensor 36), etc. External server(s) 60 may receive the POI information from head-mounted device 10 and identify a point of interest in the point of interest database 84 that matches the received POI information. After identifying the matching point of interest, external server(s) 60 may transmit information associated with the matching pointed of interest such as application information 78 and contextual information 80 to head-mounted device 10.

Control circuitry 64 in external server(s) 60 may include one or more machine learning classifiers to identify a matching point of interest based on received information (e.g., from head-mounted device 10). The machine learning classifier may identify a point of interest that matches a received data set with a probability value (e.g., a 99% chance of the received data set matching the first point of interest, an 80% chance of the received data set matching the first point of interest, a 50% chance of the received data set matching the first point of interest, etc.). Above a predetermined threshold (e.g., 80%), the point of interest in the database may be identified as a match to the received data set. When external server(s) 60 receive a request for POI information and identify a match, the external server(s) may transmit information associated with the matching point of interest to the requesting device. Below the predetermined threshold, the point of interest may not be identified as a match. When the received data set does not match any points of interest in database 64, the external server(s) may inform the requesting device that no match was available.

The machine learning classifier may continuously update point of interest database 84 based on received data sets from various external electronic devices such as head-mounted device 10. In this way, changes in the points of interest may be identified over time. Consider a given point of interest that is stored in the database 84 with information identifying the given point of interest as having a red door. At a given point in time, the door may be painted to change its color from red to green. The first request external server(s) 60 receives after the door is painted may have a mismatch for the door color attribute. All other attributes of the point of interest in the received data set may match the attributes of the given point of interest in the database. However, the received data set may identify the door as green (since this is real time data after the door is painted) whereas the database may still identify the door as red (since the stored data is based on historical data from before the door was painted). For the first request, the door color may be identified as a mismatch. However, as subsequent requests regarding the given point of interest are received that all identify the door as green, the machine learning classifier may identify that the door color has changed from red to green and change the door color attribute from red to green in its database. In this way, requests received from various electronic devices are sufficient for the database 84 to be updated to reflect actual changes to the physical environment without needing to be manually updated (e.g., by an owner of the point of interest).

Any desired machine learning classifier types/techniques may be used in external server(s) 60 (e.g., neural network, perceptron, naive Bayes, decision tree, logistic regression, K-nearest neighbor, support vector machine, etc.).

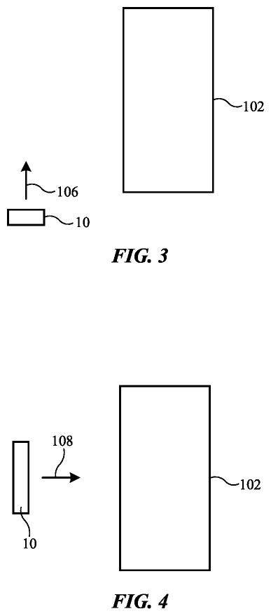

FIGS. 3 and 4 are top views of a three-dimensional environment showing how a user may encounter a point of interest and request corresponding content associated with the point of interest. In the example of FIG. 3, head-mounted device 10 may be both facing direction 106 and traveling in direction 106 (e.g., while being transported by a user). A point of interest 102 is in the vicinity of head-mounted device 10. In FIG. 4, the head-mounted device 10 may be stationary (e.g., because the user has stopped moving) and facing direction 108 towards point of interest 102.

In FIG. 3, no user intent for content (e.g., content associated with a point of interest) has been detected. Accordingly, one or more of the sensors in input-output circuitry 16 of head-mounted device 10 may be turned off or may operate in a low power consumption mode. In FIG. 4, a user intent for content has been detected. One or more of the sensors in input-output circuitry 16 of head-mounted device 10 may be turned on or switched into a high power consumption mode in response to detecting the user intent for content.

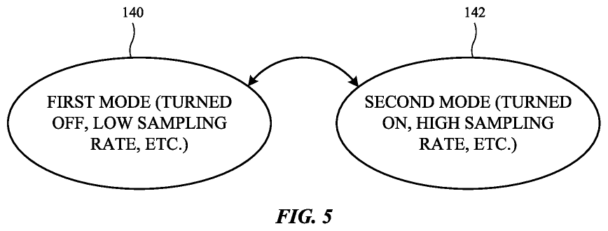

As shown by the state diagram in FIG. 5, each component (sensor) in input-output circuitry 16 may optionally be operable in a first mode 140 and a second mode 142. The second mode has a higher associated power consumption than the first mode. In general, the sensor may provide more and/or better (e.g., higher resolution) data in the second mode compared to the first mode. As an example, a first given sensor may be turned off while in the first mode and turned on while in the second mode. As another example, a second given sensor may be turned on in both the first mode and the second mode. However, the second given sensor may operate with a first sampling rate (e.g., a low sampling rate) in the first mode and a second sampling rate (e.g., a high sampling rate) that is greater than the first sampling rate in the second mode. Instead or in addition, the processing of data from the sensors can switch from a first mode to a second mode (e.g., a low power algorithm may be used to analyze images from a camera in the first mode and a high power algorithm may be used to analyze images from a camera in the second mode).

One or more sensors of input-output circuitry 16 may operate in the first mode 140 while the head-mounted device is detecting a user intent for content (e.g., content associated with a point of interest). When the user intent for content is determined, one or more sensors may switch from the first mode to the second mode 142 (with a higher power consumption than the first mode). Operating the sensors in the second mode 142 upon detection of the user intent for content may allow the head-mounted device 10 to gather additional information that may then be used to identify one or more points of interest near the user.

For example, consider an outward-facing camera 24 in head-mounted device 10. During normal operations (sometimes referred to as baseline operations) of head-mounted device 10 (e.g., before detecting the user intent for content, as in FIG. 3), the outward-facing camera 24 may operate in first mode 140. For outward-facing camera 24, the camera is turned on and operates with a first sampling frequency (e.g., 1 Hz) while in the first mode. In response to identifying the user intent for content (as in FIG. 4), the outward-facing camera 24 may switch from the first mode 140 to the second mode 142. For outward-facing camera 24, the camera is turned on and operates with a second sampling frequency (e.g., 60 Hz) that is greater than the first frequency while in the second mode. The power consumption of outward-facing camera 24 is lower in the first mode than in the second mode. In this way, power consumption of outward-facing camera 24 is reduced during normal operation. Then, when the user intent for content is detected, additional power consumption for outward-facing camera 24 is permitted to gather additional information that is used to identify point of interest information.

As another example, consider a depth sensor 36 in head-mounted device 10. During normal operation (e.g., as in FIG. 3), the depth sensor 36 may be in first mode 140. For depth sensor 36, the depth sensor is turned off while in the first mode. In other words, the data from depth sensor 36 is not needed to identify the user intent for content. In response to identifying the user intent for content (e.g., as in FIG. 4), the depth sensor may switch from the first mode 140 to the second mode 142. For depth sensor 36, the depth sensor is turned on while in the second mode. The power consumption of depth sensor 36 is lower in the first mode than in the second mode. In this way, power consumption of depth sensor 36 is reduced during normal operations. Then, when the user intent for content is detected, additional power consumption for depth sensor 36 is permitted to gather additional information that is used to identify point of interest information.

The aforementioned example of depth sensor 36 being turned off in the first, low power mode is merely illustrative. In another example, depth sensor 36 may be turned on but have a lower sampling frequency in the first mode than in the second mode.

Head-mounted device 10 may identify a user intent for content while the user is in the vicinity of point of interest 102. There are several ways in which head-mounted device 10 may identify the user intent for content.

In some cases, the user intent for content may be an explicit instruction from the user. For example, the user may provide a voice command that is recognized using microphone 26, may provide touch input to touch sensor 40, or may press button 50. This type of explicit command may cause point of interest information to be transmitted to external server(s) 60 to identify a point of interest within the field-of-view of the user.

Instead or in addition, the user intent for content may be detected based on the movement of the user's body. For example, in FIG. 4, the user's body is stationary. Position and motion sensors 28 (e.g., an accelerometer, GPS sensor 54) may detect that the user's body is stationary. Cell tower triangulation may also be used to detect the location for the head-mounted device (and when the head-mounted device is stationary). When the user's body is stationary for longer than a threshold dwell time, a user intent for content may be detected.

Instead or in addition, the user intent for content may be detected based on the movement of the user's head. For example, in FIG. 4, the user's head is stationary (looking in direction 108). Position and motion sensors 28 (e.g., an accelerometer, GPS sensor 54) may detect that the user's head is stationary. When the user's head (and, correspondingly, direction-of-view) is stationary for longer than a threshold dwell time, a user intent for content may be detected.

Instead or in addition, the user intent for content may be detected based on the movement of the user's gaze. For example, the user's gaze may be stationary (e.g., fixed at a given point on point of interest 102). Gaze-tracking sensor 48 may detect that the user's point of gaze is stationary. When the user's point of gaze is stationary for longer than a threshold dwell time, a user intent for content may be detected.

Instead or in addition, the user intent for content may be detected based on detection of a graphical marker associated with a point of interest. For example, in FIG. 4, an outward-facing camera pointing in direction 108 may capture an image of a graphical marker on point of interest 102. The presence of the graphical marker in the captured image may automatically trigger a user intent for content. Alternatively, the presence of the graphical marker in the captured image may trigger the head-mounted device 10 to present a prompt for the user to authorize obtaining point of interest information. If the prompt is accepted (e.g., obtaining point of interest information is authorized), the head-mounted device may transmit point of interest information to external server(s) 60 to identify a point of interest within the field-of-view of the user.

Upon detection of a user intent for content, the head-mounted device 10 may obtain additional information regarding the point of interest (e.g., regarding the physical environment around the user including the point of interest).

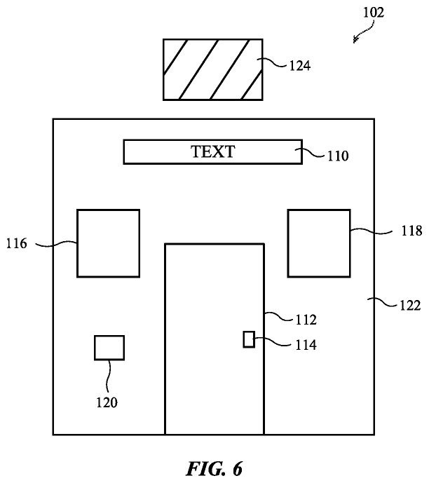

FIG. 6 is a diagram of a view of a user of a head-mounted device 10 (e.g., through display 18). As shown in FIG. 6, the physical environment including point of interest 102 is viewable through display 18. Point of interest 102 is a building 122 that includes a door 112 with a doorknob 114, windows 116 and 118, a sign 110 with corresponding text, and a graphical marker 120.

When obtaining information regarding the point of interest that is used to identify the point of interest, depth sensor 36 in head-mounted device 10 may obtain depth data regarding the point of interest. Instead or in addition, images from an outward-facing camera 24 may be analyzed to determine depth data regarding the point of interest. For example, the windows 116 and 118 may be inset from the remainder of the building. Sign 110 may protrude from the remainder of the building. Doorknob 114 has a position relative to door 112. The depth sensor may capture these characteristics and determine a three-dimensional representation of the point of interest (e.g., a depth map). This depth information may be transmitted to external server(s) 60 to help external server(s) 60 identify the point of interest the user is viewing. In other words, external server(s) 60 may compare the received depth map to known depth maps for points of interest (in database 84) to match the received depth map to a corresponding point of interest.

When obtaining information regarding the point of interest that is used to identify the point of interest, outward-facing camera 24 may capture images of point of interest 102. The images may be analyzed (e.g., by control circuitry 14) to determine the color of various physical objects associated with the point of interest. For example, the head-mounted device may determine the color of door 112, the color of building 122, the color of sign 110, etc. This color information may be transmitted to external server(s) 60 to help external server(s) 60 identify the point of interest the user is viewing. In other words, external server(s) 60 may compare the received color information to known color information for points of interest (in database 84) to match the received color information to a corresponding point of interest.

Images from outward-facing camera 24 may also be analyzed to identify graphical marker 120. The image of the graphical marker or other information associated with the graphical marker may be transmitted to external server(s) 60 to help external server(s) 60 identify the point of interest the user is viewing.

Images from outward-facing camera 24 may also be analyzed to identify text in the physical environment. For example, text on sign 110 may be identified in the images from the outward-facing camera and information regarding the text may be transmitted to external server(s) 60 to help external server(s) 60 identify the point of interest the user is viewing.

Images from outward-facing camera 24 and/or depth information from depth sensor 36 may be analyzed to identify feature points associated with the point of interest. The feature points may include edge locations, corner locations, point locations, or other feature point information associated with the point of interest.

Head-mounted device 10 may transmit various other information (e.g., GPS location information, cell tower triangulation location information, pose information, etc.) to external server(s) 60 to help external server(s) 60 identify the point of interest the user is viewing.

External server(s) 60 may receive the information from head-mounted device 10, compare the received information to known information for points of interest (in database 84), identify a matching point of interest, and transmit information for the matching point of interest to head-mounted device 10. Using the received information for the matching point of interest, head-mounted device 10 may present content. For example, as shown in FIG. 6, head-mounted device 10 may present a virtual object 124 (e.g., using display 18). The virtual object 124 may be a two-dimensional object or a three-dimensional object. The virtual object may be a head-locked, body-locked, or world-locked virtual object.

Virtual object 124 may be based on contextual information received from external server(s) 60. Consider an example where point of interest 102 is a store. The virtual object 124 may be a two-dimensional window with a description of items for sale at the store. Consider an example where point of interest 102 is a restaurant. The virtual object 124 may be a two-dimensional window with a menu for the restaurant. Consider an example where point of interest 102 is a business. The virtual object 124 may be a three-dimensional logo for the business.

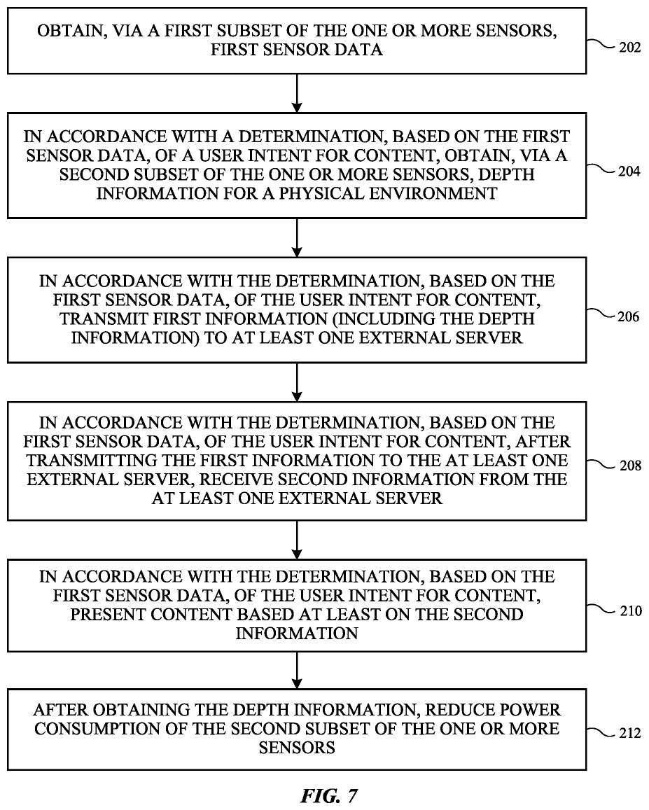

FIG. 7 is a flowchart showing an illustrative method performed by a head-mounted device (e.g., control circuitry 14 in device 10). The blocks of FIG. 7 may be stored as instructions in memory of head-mounted device 10, with the instructions configured to be executed by one or more processors in the head-mounted device.

During the operations of block 202, the head-mounted device may obtain, via a first subset of one or more sensors in the head-mounted device, first sensor data. At least some of the first subset of the sensors may operate in a low power-consuming mode (e.g., the first mode 140 in FIG. 5) during the operations of block 202. At least some of the first subset of the sensors may operate in a high power-consuming mode (e.g., the second mode 142 in FIG. 5) during the operations of block 202. In other words, any sensor that gathers sensor data during the operations of block 202 may optionally operate at a relatively low sampling frequency during the operations of block 202.

In general, the sensors used to obtain the first sensor data may include any of the sensors in the head-mounted device (e.g., inward-facing camera 22, outward-facing camera 24, microphone 26, position and motion sensors 28 such as an accelerometer, compass, and/or gyroscope, ambient light sensor 30, magnetometer 32, heart rate monitor 34, depth sensor 36, temperature sensor 38, touch sensor 40, moisture sensor 42, gas sensor 44, barometer 46, gaze-tracking sensor 48, button 50, light-based proximity sensor 52, GPS sensor 54, etc.).

To mitigate power consumption, a reduced number of sensors (compared to the total number of sensors in the head-mounted device) may be included in the first subset of the one or more sensors. Said another way, only sensors needed to monitor for and detect a user intent for content are used to gather the first sensor data. Depending on power consumption requirements for head-mounted device 10, extraneous sensors may operate during the operations of block 202 (e.g., for greater certainty in identifying the user intent for content).

As one specific example, the first sensor data may include global positioning system (GPS) data from GPS sensor 54 and position and motion data from position and motion sensors 28. This data may be sufficient to determine a user intent for content during operation of head-mounted device. In this example, inward-facing camera 22, outward-facing camera 24, microphone 26, ambient light sensor 30, depth sensor 36, temperature sensor 38, touch sensor 40, moisture sensor 42, gas sensor 44, barometer 46, gaze-tracking sensor 48, and/or light-based proximity sensor 52 may be turned off or operate in a low power consumption mode (e.g., mode 140 in FIG. 5) during the operations of block 202. This example is merely illustrative. In general, any subset of the sensors in head-mounted device 10 may be turned on during the operations of block 202. Similarly, any subset of the sensors in head-mounted device 10 may be turned off during the operations of block 202.

During the operations of block 204, in accordance with a determination, based on the first sensor data, of a user intent for content, the head-mounted device may obtain, via a second subset of the one or more sensors, depth information for a physical environment. The second subset of the one or more sensors may include at least one sensor that is not included in the first subset of the one or more sensors. The second subset of the one or more sensors may include, for example, depth sensor 36. The depth sensor may determine a three-dimensional representation of the physical environment (including a point of interest).

The first subset of the one or more sensors in block 202 may include a touch sensor and the user intent for content from block 204 may include a touch input (detected by the touch sensor).

The first subset of the one or more sensors in block 202 may include a microphone and the user intent for content from block 204 may include a voice command (detected by the microphone).

The first subset of the one or more sensors in block 202 may include an accelerometer and the user intent for content from block 204 may include a direction-of-view of the user's head (as detected by the accelerometer) remaining stationary for longer than a threshold dwell time.

The first subset of the one or more sensors in block 202 may include a GPS sensor and the user intent for content from block 204 may include a location of the user (as detected by the GPS sensor) remaining stationary for longer than a threshold dwell time.

The first subset of the one or more sensors in block 202 may include a gaze-tracking sensor and the user intent for content from block 204 may include a point of gaze of the user (as detected by the gaze-tracking sensor) remaining stationary for longer than a threshold dwell time.

In general, data from any one or more sensors in the head-mounted device may be used to detect the user intent for content.

Also during the operations of block 204 (e.g., in accordance with a determination, based on the first sensor data, of a user intent for content), the head-mounted device 10 may obtain additional sensor data (e.g., from an additional subset of the one or more sensors in the head-mounted device). Obtaining the additional sensor data may include turning on a sensor that was previously turned off and/or switching a sensor from first mode 140 to second mode 142. The additional sensor data may include one or more images of the physical environment, as captured by an outward-facing camera 24. The additional sensor data may include pose information for the head-mounted device (which corresponds to user head pose), as captured by position and motion sensors 28. In general, the additional sensor data may include any sensor data (e.g., from inward-facing camera 22, outward-facing camera 24, microphone 26, position and motion sensors 28 such as an accelerometer, compass, and/or gyroscope, ambient light sensor 30, magnetometer 32, heart rate monitor 34, depth sensor 36, temperature sensor 38, touch sensor 40, moisture sensor 42, gas sensor 44, barometer 46, gaze-tracking sensor 48, button 50, light-based proximity sensor 52, GPS sensor 54, etc.).

At least one sensor may be turned on (in a given mode) during the operations of block 202 and turned on (in the given mode) during the operations of block 204. In other words, at least one sensor may operate in the same mode (e.g., with the same power consumption) during the operations of both block 202 and block 204. For example, GPS sensor 54 may operate in the same mode during the operations of blocks 202 and 204.

At least one sensor may be turned on (in a first mode) during the operations of block 202 and turned on (in a second, different mode) during the operations of block 204. In other words, at least one sensor may operate in different modes during the operations of block 202 and block 204. The at least one sensor may operate in a mode with higher power consumption (e.g., a higher sampling frequency) during the operations of block 204 than during the operations of block 202. For example, outward-facing camera 24 may operate with a higher sampling frequency during the operations of block 204 than during the operations of block 202.

During the operations of block 206, the head-mounted device may (in accordance with the determination, based on the first sensor data, of the user intent for content) transmit (e.g., using communication circuitry 56) first information to at least one external server. The first information may include the depth information from block 204 and/or any other desired point of interest information. For example, the first information transmitted during the operations of block 206 may include one or more images of the physical environment, information regarding a graphical marker identified in one or more images of the physical environment, and/or information based on the one or more images of the physical environment. The information based on the one or more images of the physical environment may include color information for a physical object in the physical environment and/or feature points extracted from the one or more images of the physical environment.

The first information may also include location information (e.g., GPS location information from GPS sensor 54 and/or cell tower triangular location information), pose information (e.g., as determined using position and motion sensors 28), audio information from microphone 26, ambient light information from ambient light sensor 30, magnetic field information from magnetometer 32, heart rate information from heart rate monitor 34, temperature information from temperature sensor 38, touch information from touch sensor 40, moisture information from moisture sensor 42, gas information from gas sensor 44, pressure information from barometer 46, point of gaze information from gaze-tracking sensor 48, button press information from button 50, and/or proximity sensor information from light-based proximity sensor 52.

During the operations of block 208, the head-mounted device may (in accordance with the determination, based on the first sensor data, of the user intent for content), after transmitting the first information to the at least one external server, receive second information from the at least one external server. The second information may include contextual information for the physical environment. The contextual information may include an identity of a physical object in the physical environment (e.g., an identify of the point of interest, an identity of a door, window, building, sign, or other physical object associated with the point of interest, etc.). The contextual information may include an application associated with the physical environment (e.g., associated with a point of interest in the physical environment). For example, when the physical environment includes a point of interest such as a restaurant, the contextual information may include an application associated with that restaurant that allows the user of the head-mounted device to order from that restaurant.

During the operations of block 210, the head-mounted device may (in accordance with the determination, based on the first sensor data, of the user intent for content) present content based at least on the second information (from block 208). The head-mounted device may present visual content using display 18 and/or may present audio content using speaker 20. The head-mounted device may also run an application based on the second information received from the external server(s).

The second information received at block 208 may include location information for at least one physical object in the physical environment (e.g., location information for a graphical marker). During the operations of block 210, the head-mounted device may determine a location for the head-mounted device using the received location information for the at least one physical object in the physical environment. In other words, the head-mounted device may determine an initial location for the head-mounted device using GPS sensor 54 and/or cell tower triangulation. The head-mounted device may determine a more precise location for the head-mounted device using the location information for at least one physical object in the physical environment and information regarding the location of the physical object relative to the head-mounted device (e.g., from depth sensor 36). This precise location for the head-mounted device (determined using the location information for at least one physical object in the physical environment) may be used to present content during the operations of block 210.

During the operations of block 212, after obtaining the depth information, the head-mounted device may reduce power consumption of the second subset of the one or more sensors (that are used during the operations of block 204). Reducing the power consumption of the second subset of the one or more sensors may include ceasing to obtain sensor data using the second subset of the one or more sensors, turning off the second subset of the one or more sensors, reducing the sampling frequency of the second subset of the one or more sensors, and/or operating the second subset of the one or more sensors in a mode with lower power consumption than during the operations of block 204.

Also during the operations of block 212, after obtaining the second sensor data and presenting the content during the operations of block 210, the head-mounted device may continue to obtain, via the first subset of the one or more sensors, the first sensor data (as in block 202) and monitor for a user intent for content.

Consider the example of a user walking down a street in a physical environment while transporting electronic device 10 (e.g., as in FIG. 3). During the operations of block 202, electronic device 10 may use position and motion sensors 28 to obtain first sensor data and monitor the first sensor data for a user intent for content.

Next, the user may stop moving and focus their attention on a nearby point of interest (as in FIG. 4 when the user focuses on point of interest 102). The user's focusing their attention on the point of interest may be reflected in their location (which is now stationary instead of moving), direction-of-view (which is stationary), and/or point of gaze (which may be stationary on the point of interest). The sensor data from position and motion sensors 28 in block 202 may therefore reflect a user intent for content when the user focuses their attention on a nearby point of interest.

During the operations of block 204, in accordance with a determination, based on the first sensor data, of a user intent for content, electronic device 10 may turn on (or increase the sampling rate of) depth sensors 36 to obtain depth information.

Also during the operations of block 204, in accordance with a determination, based on the first sensor data, of a user intent for content, electronic device 10 may turn on (or increase the sampling rate) of one or more additional sensors (e.g., inward-facing camera 22, outward-facing camera 24, microphone 26, ambient light sensor 30, magnetometer 32, heart rate monitor 34, temperature sensor 38, touch sensor 40, moisture sensor 42, gas sensor 44, barometer 46, gaze-tracking sensor 48, button 50, light-based proximity sensor 52, etc.).

During the operations of block 206, electronic device 10 may (in accordance with the determination, based on the first sensor data, of the user intent for content) transmit first information to external server(s) 60. The first information may include the depth information from block 204 and/or additional sensor information from block 204 (e.g., from inward-facing camera 22, outward-facing camera 24, microphone 26, ambient light sensor 30, magnetometer 32, heart rate monitor 34, temperature sensor 38, touch sensor 40, moisture sensor 42, gas sensor 44, barometer 46, gaze-tracking sensor 48, button 50, light-based proximity sensor 52, etc.). The first information transmitted by electronic device 10 may include GPS location information, cell tower triangulation location information, pose information, graphical marker information, color information, feature point information, and/or depth information.

During the operations of block 208, electronic device 10 may (in accordance with the determination, based on the first sensor data, of the user intent for content) receive second information from external server(s) 60. The second information may include, for example, hours of operation for the identified point of interest.

During the operations of block 210, electronic device 10 may (in accordance with the determination, based on the first sensor data, of the user intent for content) present content based on the second information. Electronic device 10 may, for example, present a two-dimensional window that displays the hours of operation for the identified point of interest using display 18. The two-dimensional window may be fixed relative to the point of interest (e.g., world-locked).

During the operations of block 212, electronic device 10 may reduce the power consumption of depth sensor 36 (which was used to obtain data during the operations of block 204). The depth sensor may be turned off or switched into a mode with lower power consumption during the operations of block 212.

Using the second subset of the one or more sensors only when a user intent for content is detected has the benefit of reducing power consumption. Additionally, using the second subset of the one or more sensors only when a user intent for content is detected has the benefit of reducing interruptions by presenting content when it is more likely to be acceptable to the user.

It is noted that certain points of interest and/or other portions of a physical environment may opt out of participating in point of interest detection. No point of interest data is stored for these areas. A user may be unable to present content associated with these areas.

The foregoing is merely illustrative and various modifications can be made to the described embodiments. The foregoing embodiments may be implemented individually or in any combination.

What is claimed is:

1. An electronic device comprising:
one or more sensors;
one or more processors; and
memory storing instructions configured to be executed by the one or more processors, the instructions for:
obtaining, via a first subset of the one or more sensors, first sensor data; and
in accordance with a determination, based on the first sensor data, of a user intent for content:
obtaining, via a second subset of the one or more sensors, depth information for a physical environment, wherein the second subset of the one or more sensors comprises at least one sensor not included within the first subset of the one or more sensors;
transmitting first information to at least one external server, wherein the first information comprises the depth information;
after transmitting the first information to the at least one external server, receiving second information from the at least one external server, wherein the second information comprises contextual information for the physical environment; and
presenting content based at least on the second information.

2. The electronic device defined in claim 1, wherein the at least one sensor not included within the first subset of the one or more sensors is turned off during the obtaining, via the first subset of the one or more sensors, the first sensor data.

3. The electronic device defined in claim 1, wherein obtaining, via the second subset of the one more sensors, the second sensor data comprises operating at least one of the second subset of the one or more sensors using a sampling frequency and wherein the instructions further comprise instructions for:
after obtaining the second sensor data, reducing the sampling frequency of the at least one of the second subset of the one or more sensors.

4. The electronic device defined in claim 1, wherein:
the first subset of the one or more sensors comprises an accelerometer;
the first sensor data comprises accelerometer data; and
the determination of the user intent for content comprises determining, based on the accelerometer data, a given direction-of-view lasting for longer than a threshold dwell time.

5. The electronic device defined in claim 1, wherein the instructions further comprise instructions for:
obtaining, via a third subset of the one or more sensors, one or more images of the physical environment, wherein the first information comprises information based on the one or more images of the physical environment.

6. The electronic device defined in claim 5, wherein the information based on the one or more images of the physical environment comprises color information for a physical object in the physical environment, feature points extracted from the one or more images of the physical environment, or information regarding a graphical marker identified in the one or more images of the physical environment.

7. The electronic device defined in claim 1, wherein the contextual information for the physical environment comprises an identity of a physical object in the physical environment or an application associated with the physical environment.

8. The electronic device defined in claim 1, further comprising:
one or more displays; and
one or more speakers, wherein presenting content based at least on the second information comprises presenting visual content using the one or more displays and presenting audio content using the one or more speakers.

9. A method of operating an electronic device that comprises one or more sensors, the method comprising:
obtaining, via a first subset of the one or more sensors, first sensor data; and
in accordance with a determination, based on the first sensor data, of a user intent for content:
obtaining, via a second subset of the one or more sensors, depth information for a physical environment, wherein the second subset of the one or more sensors comprises at least one sensor not included within the first subset of the one or more sensors;
transmitting first information to at least one external server, wherein the first information comprises the depth information;
after transmitting the first information to the at least one external server, receiving second information from the at least one external server, wherein the second information comprises contextual information for the physical environment; and
presenting content based at least on the second information.

10. The method defined in claim 9, wherein the at least one sensor not included within the first subset of the one or more sensors is turned off during the obtaining, via the first subset of the one or more sensors, the first sensor data.

11. The method defined in claim 9, wherein obtaining, via the second subset of the one more sensors, the second sensor data comprises operating at least one of the second subset of the one or more sensors using a sampling frequency and wherein the method further comprises:
after obtaining the second sensor data, reducing the sampling frequency of the at least one of the second subset of the one or more sensors.

12. The method defined in claim 9, wherein:
the first subset of the one or more sensors comprises an accelerometer;
the first sensor data comprises accelerometer data; and
the determination of the user intent for content comprises determining, based on the accelerometer data, a given direction-of-view lasting for longer than a threshold dwell time.

13. The method defined in claim 9, further comprising:
obtaining, via a third subset of the one or more sensors, one or more images of the physical environment, wherein the first information comprises information based on the one or more images of the physical environment.

14. The method defined in claim 13, wherein the information based on the one or more images of the physical environment comprises color information for a physical object in the physical environment, feature points extracted from the one or more images of the physical environment, or information regarding a graphical marker identified in the one or more images of the physical environment.

15. The method defined in claim 9, wherein the contextual information for the physical environment comprises an identity of a physical object in the physical environment or an application associated with the physical environment.

16. The method defined in claim 9, wherein the electronic device further comprises one or more displays and one or more speakers and wherein presenting content based at least on the second information comprises presenting visual content using the one or more displays and presenting audio content using the one or more speakers.

17. A non-transitory computer-readable storage medium storing one or more programs configured to be executed by one or more processors of an electronic device that comprises one or more sensors, the one or more programs including instructions for:
obtaining, via a first subset of the one or more sensors, first sensor data; and
in accordance with a determination, based on the first sensor data, of a user intent for content:
obtaining, via a second subset of the one or more sensors, depth information for a physical environment, wherein the second subset of the one or more sensors comprises at least one sensor not included within the first subset of the one or more sensors;
transmitting first information to at least one external server, wherein the first information comprises the depth information;
after transmitting the first information to the at least one external server, receiving second information from the at least one external server, wherein the second information comprises contextual information for the physical environment; and
presenting content based at least on the second information.

18. The non-transitory computer-readable storage medium defined in claim 17, wherein the at least one sensor not included within the first subset of the one or more sensors is turned off during the obtaining, via the first subset of the one or more sensors, the first sensor data.

19. The non-transitory computer-readable storage medium defined in claim 17, wherein obtaining, via the second subset of the one more sensors, the second sensor data comprises operating at least one of the second subset of the one or more sensors using a sampling frequency and wherein the instructions further comprise instructions for:
after obtaining the second sensor data, reducing the sampling frequency of the at least one of the second subset of the one or more sensors.

20. The non-transitory computer-readable storage medium defined in claim 17, wherein:
the first subset of the one or more sensors comprises an accelerometer;
the first sensor data comprises accelerometer data; and
the determination of the user intent for content comprises determining, based on the accelerometer data, a given direction-of-view lasting for longer than a threshold dwell time.

21. The non-transitory computer-readable storage medium defined in claim 17, wherein the instructions further comprise instructions for:
obtaining, via a third subset of the one or more sensors, one or more images of the physical environment, wherein the first information comprises information based on the one or more images of the physical environment.

22. The non-transitory computer-readable storage medium defined in claim 21, wherein the information based on the one or more images of the physical environment comprises color information for a physical object in the physical environment, feature points extracted from the one or more images of the physical environment, or information regarding a graphical marker identified in the one or more images of the physical environment.

23. The non-transitory computer-readable storage medium defined in claim 17, wherein the contextual information for the physical environment comprises an identity of a physical object in the physical environment or an application associated with the physical environment.

24. The non-transitory computer-readable storage medium defined in claim 17, wherein the electronic device further comprises one or more displays and one or more speakers and wherein presenting content based at least on the second information comprises presenting visual content using the one or more displays and presenting audio content using the one or more speakers.
